(19) United States
(12) Patent Application Publication
(10) Pub. No.: US 2018/0083759 A1
(43) Pub. Date: Mar. 22, 2018

(54) FRONT-END CIRCUIT, ANTENNA CIRCUIT, AND COMMUNICATION APPARATUS

(71) Applicant: Murata Manufacturing Co., Ltd., Kyoto (JP)

(72) Inventors: Kengo Onaka, Kyoto (JP); Katsuhito Kuroda, Kyoto (JP)

(21) Appl. No.: 15/825,354

(22) Filed: Nov. 29, 2017

Related U.S. Application Data
(63) Continuation of application No. PCT/JP2016/061344, filed on Apr. 7, 2016.

(30) Foreign Application Priority Data
Jun. 1, 2015 (JP) 2015-111055

(51) Int. Cl. H04L 5/00; H04L 5/02; H01Q 5/335

(52) U.S. Cl. CPC H04L 5/0098; H01Q 5/335; H04L 5/023

(57) ABSTRACT

A front-end circuit includes a band switching unit (20) that is directly or indirectly connected to an antenna (10) and that switches connection to a frequency band used in transmission and reception, among multiple frequency bands, multiple demultiplexers (31 to 34) that perform demultiplexing into transmission signals and reception signals in the respective frequency bands, and antenna matching circuits (41 to 44). One of the antenna matching circuits (41 to 44) is disposed between at least one demultiplexer, among the multiple demultiplexers (31 to 34), and the band switching unit (20). For example, the antenna matching circuits (41 to 44) include reactance elements (L1, L2, C32, C42) that are connected in series to circuits connecting the band switching unit (20) to the demultiplexers (31 to 34) and reactance elements (C1, C2, C31, C41) that are connected in parallel thereto, respectively.

This is a continuation of International Application No. PCT/JP2016/061344 filed on Apr. 7, 2016 which claims priority from Japanese Patent Application No. 2015-111055 filed on Jun. 1, 2015. The contents of these applications are incorporated herein by reference in their entireties.

### BACKGROUND OF THE DISCLOSURE

### Field of the Disclosure

The present disclosure relates to a front-end circuit that commonly uses one antenna in transmission and reception in multiple frequency bands in, for example, a wireless communication apparatus, an antenna circuit including the front-end circuit, and a communication apparatus.

### Description of the Related Art

An antenna circuit supporting multiple frequency bands, which is provided in, for example, a portable electronic device, is composed of an antenna and a front-end circuit connected to the antenna, as illustrated in Patent Document 1.

In a front-end circuit in the related art, in order for the antenna to support the respective frequency bands, an antenna tuner 80 is often directly connected to an antenna 10, for example, as illustrated in FIG. 15. In the example illustrated in FIG. 15, a diplexer 70 is connected to the antenna tuner 80, and a low-band communication circuit and a high-band communication circuit are connected to the diplexer 70.

FIG. 16 is a graph illustrating the return loss characteristics when the value of the inductance of a second inductor is switched in a case in which the antenna tuner 80 is composed of a first inductor that is shunt-connected at the diplexer 70 side and the second inductor connected in series to the antenna 10. Since switching the value of the inductance enables antenna matching in two frequency bands, it is possible to provide the performance of the antenna. Similarly, varying the reactance enables the antenna matching in a certain frequency band.

A semiconductor switch is used for switching between the reactance elements in the antenna tuner 80. Semiconductor variable capacitance elements are used as the variable reactance elements.

Patent Document 1: International Publication No. 2006/013753

### BRIEF SUMMARY OF THE DISCLOSURE

Although the antenna tuner including an antenna matching circuit is disposed between the antenna and a band switching unit (switch, diplexer, or the like) that switches connection to a frequency band used in transmission and reception, among multiple frequency bands, and the antenna matching circuit is commonly used to perform the antenna matching in the multiple frequency bands in the related art, as described above, antenna matching values optimal for the respective frequency bands are practically different from each other. Accordingly, since the antenna matching values optimal for respective frequency bands are not supported when the antenna matching is performed before the band switching unit, the accuracy of the antenna matching for the respective frequency bands is reduced.

If a transmission line from the antenna to the antenna matching circuit is lengthened, the phase is rotated and the impedance locus in a Smith chart is made long. The matching in the state in which the impedance locus is made long narrows the frequency band to be subjected to the matching.

Accordingly, when the antenna matching is to be performed after a demultiplexer including a duplexer or a diplexer (at an integrated circuit (IC) side of the demultiplexer), there is a problem in that the matching is performed in the state in which the impedance locus is made long to narrow the frequency band to be subjected to the matching.

It is an object of the present disclosure to provide a front-end circuit having a wide frequency band to be subjected to the matching while increasing the accuracy of the antenna matching for each frequency band, an antenna circuit, and a communication apparatus.

(1) The present disclosure provides a front-end circuit including a band switching unit that is directly or indirectly connected to an antenna and that switches connection to a frequency band used in transmission and reception, among multiple frequency bands; multiple demultiplexers that perform demultiplexing into transmission signals and reception signals in the respective frequency bands; and an antenna matching circuit. The antenna matching circuit is disposed between at least one demultiplexer, among the multiple demultiplexers, and the band switching unit.

With the above configuration, since no antenna tuner is directly connected to the antenna, no distortion occurs to improve the performance of the antenna. In addition, since the matching is performed for each individual port of the switch, that is, for each duplexer or each frequency band, the accuracy of the matching is improved. Furthermore, since the matching circuits of the respective frequency bands are isolated with the switch, it is not necessary to consider the matching circuits of the other frequency bands, and the matching circuits of the respective frequency bands are not affected by the other frequency bands.

(2) In (1) described above, the antenna matching circuit is preferably connected to the band switching unit side, compared with the multiple demultiplexers. With this configuration, the rotation of the phase on a transmission line from the antenna to the antenna matching circuit is suppressed to improve the accuracy of the matching with the antenna matching circuit.

(3) In (1) described above, the antenna matching circuit is preferably directly connected to the band switching unit. With this configuration, no unnecessary parasitic component occurs on the transmission line to improve the accuracy of the matching with the antenna matching circuit.

(4) In any of (1) to (3) described above, the antenna matching circuit includes, for example, a reactance element that is connected in series to a circuit connecting the band switching unit to the demultiplexer and a reactance element that is connected in parallel thereto. With this configuration, the antenna matching is achieved using a smaller number of elements.

(5) In any of (1) to (4) described above, the length of a transmission line between the antenna and the band switching unit is preferably 0.05 of wavelength or less.

If the transmission line from the antenna to the antenna matching circuit is lengthened, the phase is rotated and the impedance locus in a Smith chart is made long. The matching in the state in which the impedance locus is made long narrows the frequency band to be subjected to the matching. With the above configuration, since the length of the transmission line from the antenna to the antenna matching circuit is short, that is, 0.05 of the wavelength or less, the frequency band to be subjected to the matching is widened.

(6) In any of (1) to (5) described above, it is important that no antenna tuner containing semiconductor as a major component and no antenna tuner including a passive element is disposed between the antenna and the band switching unit. This prevents the distortion caused by the antenna tuner from occurring to improve the performance of the antenna.

(7) In any of (1) to (6) described above, a circuit composed of only a transmission line or a passive element is preferably disposed between the antenna and the band switching unit. With this configuration, no distortion occurs in the circuit between the antenna and the band switching unit to improve the performance of the antenna.

(8) In any of (1) to (7) described above, the antenna matching circuits may be provided between all the demultiplexers and the band switching unit. With this configuration, it is possible to accurately achieve the performance of the antenna for the respective frequency bands.

(9) In any of (1) to (7) described above, the antenna matching circuit may be provided only between a demultiplexer that performs demultiplexing into a transmission signal and a reception signal in a low frequency band, among the multiple demultiplexers, and the band switching unit. With this configuration, the number of the antenna matching circuits is decreased while keeping quality characteristics. Since the antenna is generally designed so as to be shorter than the wavelength in its resonant mode with a decrease in size of an electronic device into which the antenna is incorporated, the radiation resistance in the low band is lower than that in the high band. In other words, the necessity to provide the matching circuit in the high band is lower than that in the low band. Accordingly, the provision of the antenna matching circuit only in the low band enables the number of the antenna matching circuits to be decreased while keeping the quality characteristics.

(10) In (9) described above, the low frequency band is, for example, a frequency band of 1 GHz or less.

(11) In any of (1) to (10) described above, the front-end circuit preferably further includes a power amplifier connected to a transmission signal port of the demultiplexer. With this configuration, the number of the components is decreased.

(12) The present disclosure provides an antenna circuit including the front-end circuit described in any of (1) to (11) described above and an antenna connected to the front-end circuit.

(13) The present disclosure provides a communication apparatus including the front-end circuit described in any of (1) to (11) described above, an antenna connected to the front-end circuit, and a communication circuit connected to the demultiplexers.

According to the present disclosure, disposing the antenna matching circuit between the band switching unit and the demultiplexers enables the accuracy of the antenna matching for each frequency band to be improved. In addition, since the above disposition enables the transmission line from the antenna to the antenna matching circuit to be shortened, the frequency band to be subjected to the matching can be widened, compared with a case in which the antenna matching is performed at the IC side of the demultiplexers.

### BRIEF DESCRIPTION OF THE SEVERAL VIEWS OF THE DRAWINGS

FIG. 1 is a circuit diagram of a front-end circuit 101 and an antenna circuit 201 according to a first embodiment.

FIG. 2 is an equivalent circuit diagram in a state in which a band switching unit 20 in the antenna circuit 201 illustrated in FIG. 1 selects a certain port.

FIG. 3 is a graph illustrating frequency characteristics of return loss when the antenna 10 side is viewed from a feed circuit 9.

FIG. 4 is a circuit diagram of a front-end circuit 102 and an antenna circuit 202 according to a second embodiment.

FIG. 5 is a graph illustrating the frequency characteristics of the return loss when the antenna 10 side is viewed from the feed circuit 9 in a case in which the line length of a transmission line 60 in FIG. 2 is set to 0 mm.

FIG. 6 is a graph illustrating the frequency characteristics of the return loss when the antenna 10 side is viewed from the feed circuit 9 in a case in which the line length of the transmission line 60 in FIG. 2 is set to 35 mm.

FIG. 7 is a graph illustrating the frequency characteristics of the return loss when the antenna 10 side is viewed from the feed circuit 9 in a case in which the line length of the transmission line 60 in FIG. 2 is set to 105 mm.

FIG. 8 is a graph illustrating an example of the difference in the frequency characteristics of the return loss when the line length of the transmission line 60 is varied in Band12 (the center frequency is 727 MHz).

FIG. 9 is a graph illustrating a decreasing trend of the bandwidth in Band12 with the increase in the line length of the transmission line 60.

FIG. 10 is a circuit diagram of a front-end circuit 103 and an antenna circuit 203 according to a third embodiment.

FIG. 11 is a circuit diagram of a front-end circuit 104 and an antenna circuit 204 according to a fourth embodiment.

FIG. 12 is a circuit diagram of a front-end circuit 105 and an antenna circuit 205 according to a fifth embodiment.

FIG. 13 is a circuit diagram of an antenna circuit 206 according to a sixth embodiment.

FIG. 14 is a block diagram of a communication apparatus 307 according to a seventh embodiment.

FIG. 15 is a circuit diagram of an antenna circuit in which an antenna tuner is directly connected to an antenna.

FIG. 16 is a graph illustrating return loss characteristics when the inductance of a second inductor is switched in a case in which an antenna tuner 80 is composed of a first inductor that is shunt-connected at a diplexer 70 side and the second inductor connected in series to the antenna 10.

### DETAILED DESCRIPTION OF THE DISCLOSURE

Multiple embodiments of the present disclosure will herein be described with reference to the drawings, taking several specific examples. The same reference numerals are used in the drawings to identify the same components. Although the embodiments are separately described for convenience in consideration of the description of main points or ease of understanding, components described in different embodiments may be partially replaced or combined with each other. Description of points common to the first embodiment will be omitted and only the points different from the first embodiment will be described in the second and subsequent embodiments. In particular, similar effects and advantages achieved by similar components are not duplicated in each embodiment.

### First Embodiment

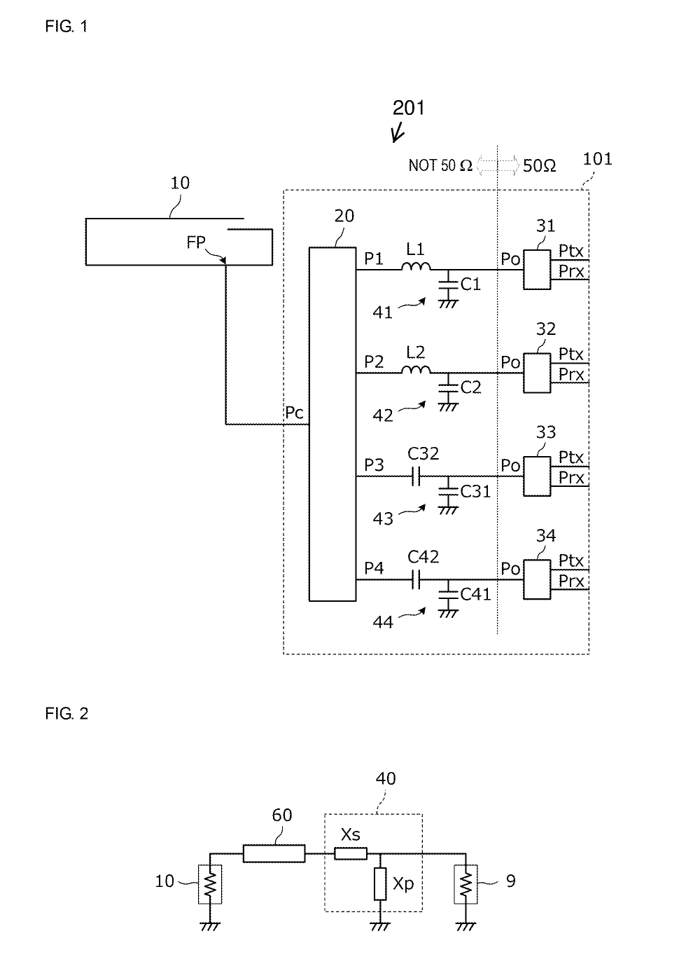

FIG. 1 is a circuit diagram of a front-end circuit 101 and an antenna circuit 201 according to a first embodiment. The antenna circuit 201 is composed of the front-end circuit 101 and an antenna 10.

The front-end circuit 101 includes a band switching unit 20, demultiplexers 31, 32, 33, and 34, and antenna matching circuits 41, 42, 43, and 44. The band switching unit 20 has a common port Pc to which the antenna 10 is connected and multiple individual ports P1, P2, P3, and P4. The band switching unit 20 is, for example, a switch or a diplexer. The band switching unit 20 switches the connection to the multiple demultiplexers 31, 32, 33, and 34 to select a certain frequency band. Each of the demultiplexers 31, 32, 33, and 34 has a transmission-reception signal port Po, a transmission signal port Ptx, and a reception signal port Prx and performs demultiplexing into a transmission signal and a reception signal. Each of the demultiplexers 31, 32, 33, and 34 is, for example, a duplexer or a diplexer including a combination of filters, such as a band pass filter, a low pass filter, and/or a high pass filter.

The antenna matching circuits 41, 42, 43, and 44 are provided between the individual ports P1, P2, P3, and P4 of the band switching unit 20 and the transmission-reception signal ports Po of the demultiplexers 31, 32, 33, and 34, respectively. The antenna matching circuits 41, 42, 43, and 44 may be directly connected to the band switching unit 20. In this case, since transmission lines from the antenna to the antenna matching circuits are further shortened, as described below, antenna characteristics are further improved.

The antenna 10 is a T-shaped radiating element in which both ends are folded and both end portions are close to each other. Power is supplied to the antenna 10 from a feed point FP.

An antenna tuner including a semiconductor element using a semiconductor signal propagation path does not exist between the antenna 10 and the band switching unit 20 but a transmission line is disposed between the antenna 10 and the band switching unit 20. When the antenna tuner includes a semiconductor switch with a reactance element or includes a semiconductor variable capacitance element, harmonic distortion or intermodulation distortion caused by impedance non-linearity occurs. Accordingly, for example, in carrier aggregation, if the frequency components of the distortion are overlapped with another reception band that is used, a failure such as degradation of reception sensitivity occurs. According to the present embodiment, since the antenna tuner including a semiconductor element using a semiconductor signal propagation path does not exist between the antenna 10 and the band switching unit 20, as described above, the failure such as degradation of the reception sensitivity is prevented.

FIG. 2 is an equivalent circuit diagram in a state in which the band switching unit 20 in the antenna circuit 201 illustrated in FIG. 1 selects a certain port. Referring to FIG. 2, an antenna matching circuit 40 is a representative of the antenna matching circuit selected by the band switching unit 20, among the antenna matching circuits 41, 42, 43, and 44 in FIG. 1. The antenna matching circuit 40 is composed of a reactance element Xs that is connected in series and a reactance element Xp that is connected in parallel (shunt-connected). A feed circuit 9 is connected to the antenna matching circuit 40. A transmission line 60 is connected between the antenna matching circuit 40 and the antenna 10. The transmission line 60 corresponds to the path from the antenna matching circuit (any of the antenna matching circuits 41, 42, 43, and 44) to the antenna 10 in FIG. 1. The line length of the transmission line 60 is set to 70 mm here.

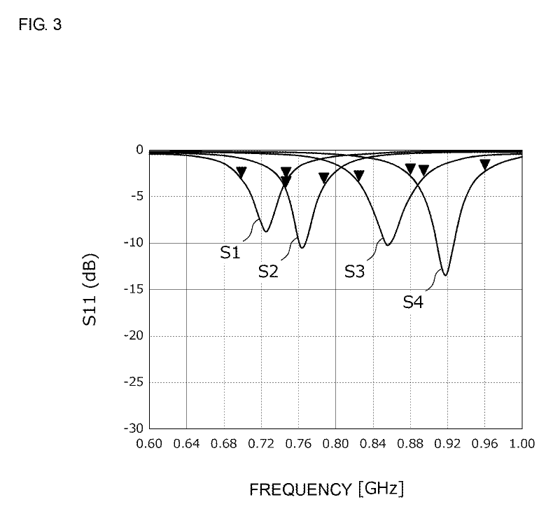

FIG. 3 is a graph illustrating frequency characteristics of return loss when the antenna 10 side is viewed from the feed circuit 9. The impedance of the antenna is calculated using the result of a typical branched monopole, which is calculated through simulation. Referring to FIG. 3, characteristics S1, S2, S3, and S4 are characteristics when the band switching unit 20 illustrated in FIG. 1 selects the individual ports P1, P2, P3, and P4, respectively. The values of the respective reactance elements in the antenna matching circuits 41 to 44 illustrated in FIG. 1 are as follows:

L1: 2 nH C1: 15 pF

L2: 0.4 nH C2: 15 pF

C32: 15 pF C31: 8 pF

C42: 5 pF C41: 5 pF

The frequency bands used by the characteristics S1, S2, S3, and S4 when the band switching unit 20 selects the individual ports P1, P2, P3, and P4 are as follows:

S1: 699 MHz or more and lower than 746 MHz

S2: 746 MHz or more and lower than 787 MHz

S3: 824 MHz or more and lower than 894 MHz

S4: 880 MHz or more and lower than 960 MHz

Triangular markers in FIG. 3 indicate the bandwidths of the respective frequency bands.

Disposing the antenna matching circuits between the band switching unit and the demultiplexers in the above manner enables the accuracy of the antenna matching for each frequency band to be improved. In addition, since the above disposition enables the transmission line from the antenna to each antenna matching circuit to be shortened, the frequency band to be subjected to the matching can be widened, compared with a case in which the antenna matching is performed at the IC side of the demultiplexers.

Since non-disposition of the antenna tuner containing a semiconductor material as a major component between the band switching unit 20 and the antenna 10 reduces the problems of the harmonic distortion or the intermodulation distortion caused by the impedance non-linearity, the performance of the antenna is improved.

In addition, since the matching circuits of the respective frequency bands are isolated from each other with the band switching unit 20, it is not necessary to consider the matching circuits of the other frequency bands, and the matching circuits of the respective frequency band are not affected by the other frequency bands.

Furthermore, the number of the components in the matching circuits is decreased, the number of variable frequency circuits is decreased, and the transmission line is shortened. Accordingly, total radiated power (TRP) and total isotropic sensitivity (TIS) are improved, the cost is reduced, and the time to design the antenna is shortened.

### Second Embodiment

The effect of the length of the transmission line between the antenna and the common port of the band switching unit on the antenna matching will be described in a second embodiment.

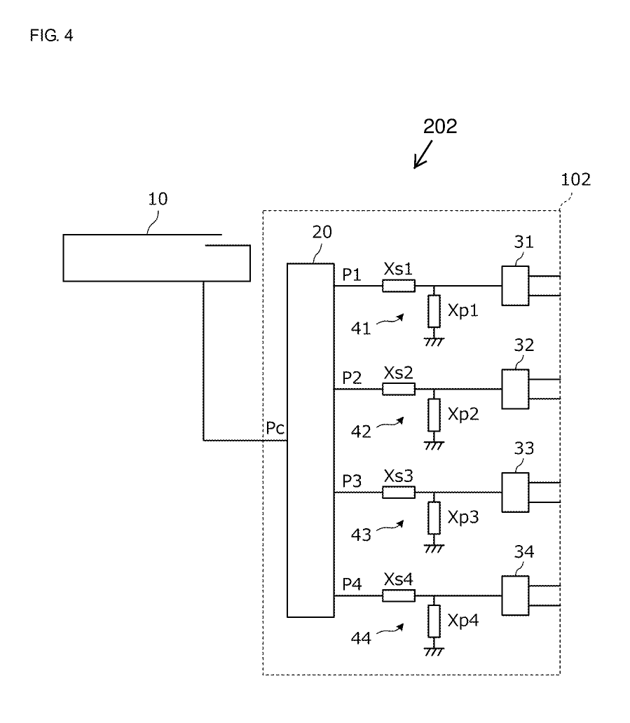

FIG. 4 is a circuit diagram of a front-end circuit 102 and an antenna circuit 202 according to the second embodiment. The antenna circuit 202 is composed of the front-end circuit 102 and the antenna 10. In the antenna circuit 202 of the present embodiment, the antenna matching circuit 41 is composed of a reactance element Xs1 that is connected in series and a reactance element Xp1 that is connected in parallel (shunt-connected), the antenna matching circuit 42 is composed of a reactance element Xs2 that is connected in series and a reactance element Xp2 that is connected in parallel (shunt-connected), the antenna matching circuit 43 is composed of a reactance element Xs3 that is connected in series and a reactance element Xp3 that is connected in parallel (shunt-connected), and the antenna matching circuit 44 is composed of a reactance element Xs4 that is connected in series and a reactance element Xp4 that is connected in parallel (shunt-connected). The equivalent circuit diagram in the state in which the band switching unit 20 in the antenna circuit selects a certain port is the same as the one illustrated in FIG. 2.

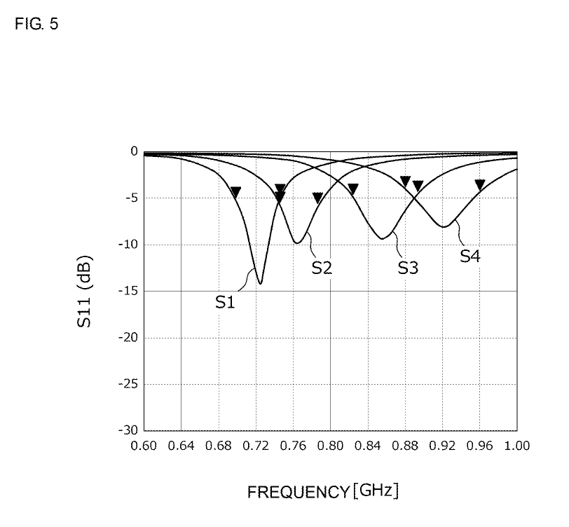

FIG. 5 is a graph illustrating the frequency characteristics of the return loss when the antenna 10 side is viewed from the feed circuit 9 in a case in which the line length of the transmission line 60 in FIG. 2 is set to 0 mm. Referring to FIG. 5, the characteristics S1, S2, S3, and S4 are characteristics when the band switching unit 20 illustrated in FIG. 4 selects the individual ports P1, P2, P3, and P4, respectively. The values of the respective reactance elements in the antenna matching circuits 41, 42, 43, and 44 illustrated in FIG. 4 are as follows:

Xs1: 12 nH Xp1: 5 nH

Xs2: 9 nH Xp2: 5 nH

Xs3: 3.5 nH Xp3: 5 nH

Xs4: 0.43 nH Xp4: 5 nH

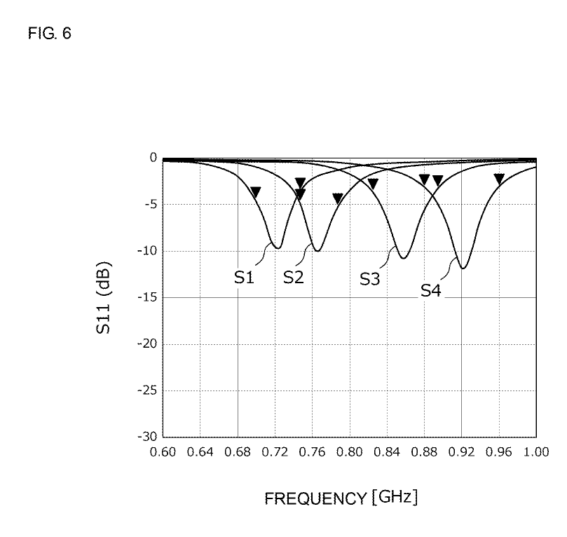

FIG. 6 is a graph illustrating the frequency characteristics of the return loss when the antenna 10 side is viewed from the feed circuit 9 in a case in which the line length of the transmission line 60 in FIG. 2 is set to 35 mm. Referring to FIG. 6, the characteristics S1, S2, S3, and S4 are characteristics when the band switching unit 20 illustrated in FIG. 4 selects the individual ports P1, P2, P3, and P4, respectively. The values of the respective reactance elements in the antenna matching circuits 41, 42, 43, and 44 illustrated in FIG. 4 are as follows:

Xs1: 2.2 nH Xp1: 3.4 nH

Xs2: 0.8 nH Xp2: 3.1 nH

Xs3: 3.5 nH Xp3: 10 pF

Xs4: 1.2 nH Xp4: 8 pF

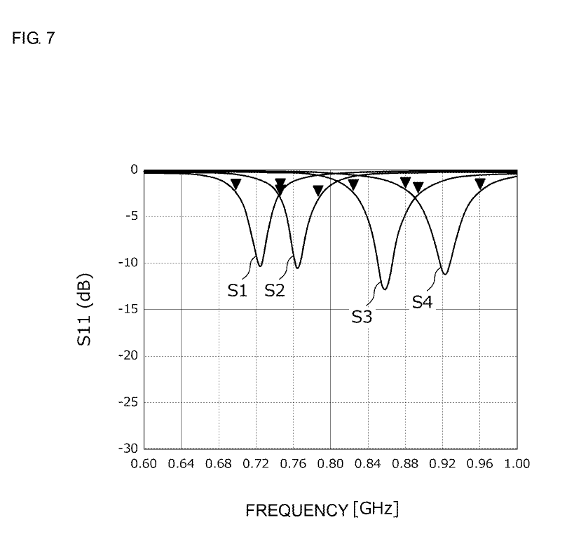

FIG. 7 is a graph illustrating the frequency characteristics of the return loss when the antenna 10 side is viewed from the feed circuit 9 in a case in which the line length of the transmission line 60 in FIG. 2 is set to 105 mm. Referring to FIG. 7, the characteristics S1, S2, S3, and S4 are characteristics when the band switching unit 20 illustrated in FIG. 4 selects the individual ports P1, P2, P3, and P4, respectively. The values of the respective reactance elements in the antenna matching circuits 41, 42, 43, and 44 illustrated in FIG. 4 are as follows:

Xs1: 11 pF Xp1: 13 pF

Xs2: 6.5 pF Xp2: 10.5 pF

Xs1: 1.8 pF Xp3: 1.8 pF

Xs4: 20 nH Xp4: 1.2 pF

The frequency bands used by the characteristics S1, S2, S3, and S4 when the band switching unit 20 selects the individual ports P1, P2, P3, and P4 in FIG. 5, FIG. 6, and FIG. 7 are the same as the ones described in the first embodiment.

As described above, when the antenna matching is performed for each frequency band in the case in which the line length of the transmission line is set to 0 mm, the return loss at the edges of each frequency band is about −4 dB to −5.7 dB, as illustrated in FIG. 5, and excellent return loss is achieved. When the antenna matching is performed for each frequency band in the case in which the line length of the transmission line is set to 35 mm, the return loss at the edges of each frequency band is about −3 dB to −4.5 dB, as illustrated in FIG. 6. When the antenna matching is performed for each frequency band in the case in which the line length of the transmission line is set to 105 mm, the return loss at the edges of each frequency band is about −2.2 dB to −3 dB, as illustrated in FIG. 7. This means that the return loss at the edges of each frequency band is reduced as the line length of the transmission line 60 is increased. The return loss at the edges of each frequency band in the case in which the line length of the transmission line is set to 70 mm is about −2.5 dB to −4 dB, as illustrated in FIG. 3 in the first embodiment.

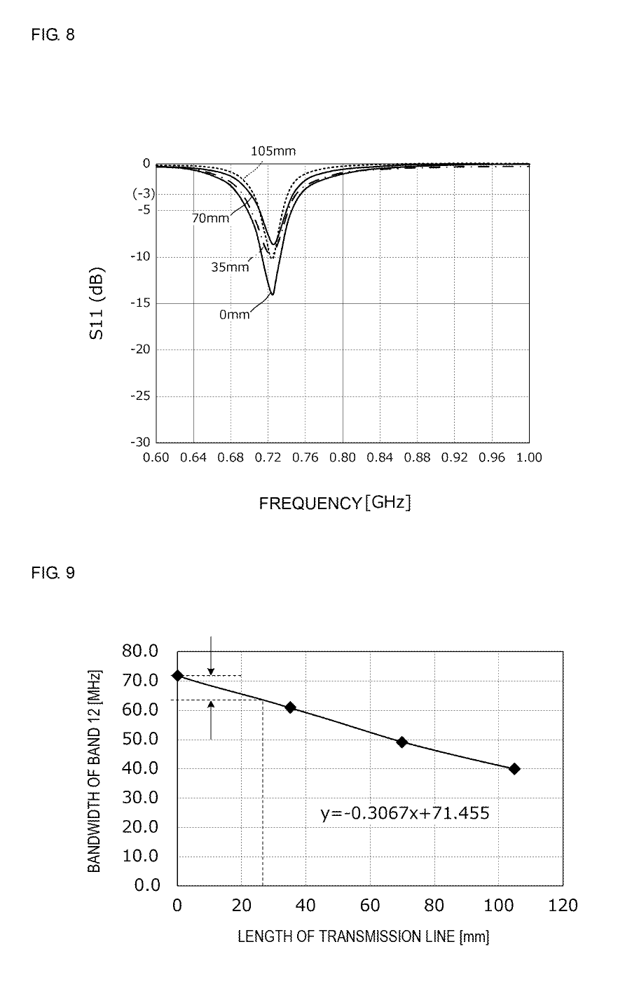

FIG. 8 is a graph illustrating an example of the difference in the frequency characteristics of the return loss when the line length of the transmission line 60 is varied in Band12 (the center frequency is 727 MHz). As illustrated in FIG. 8, the bandwidth at a return loss of −3 dB is narrowed with the increasing line length of the transmission line 60. In other words, since the line length of the transmission line 60 is long, the frequency band in which the antenna matching is achieved is narrowed.

FIG. 9 is a graph illustrating a decreasing trend of the bandwidth in Band12 with the increase in the line length of the transmission line 60. The relationship between the line length of the transmission line 60 and the bandwidth value at −3 dB is as follows:

| Line Length | Bandwidth |
|---|---|
| 0 | 71.5 |
| 35 | 61.0 |
| 70 | 49.2 |
| 105 | 39.7 |

In the characteristic line illustrated in FIG. 9, y=−0.3067×+71.455 where the length of the transmission line 60 is denoted by x and the bandwidth is denoted by y.

As illustrated in FIG. 9, degradation of the bandwidth is suppressed to 10% or less (with respect to the bandwidth when the length of the transmission line is zero) (it is considered that almost no degradation is caused) if the line length of the transmission line 60 is set to 20 mm or less (is set to 0.05 of the wavelength or less because the reduction ratio of the wavelength of the transmission line is 1.00 and the center frequency is 727 MHz). Since the degradation of the bandwidth of 10% or less is generally within an acceptable error range in measurement of each apparatus, it is considered that almost no degradation is caused if the degradation of the bandwidth is within this range.

### Third Embodiment

A front-end circuit having a configuration different from that of the example described in the first embodiment will be described in a third embodiment.

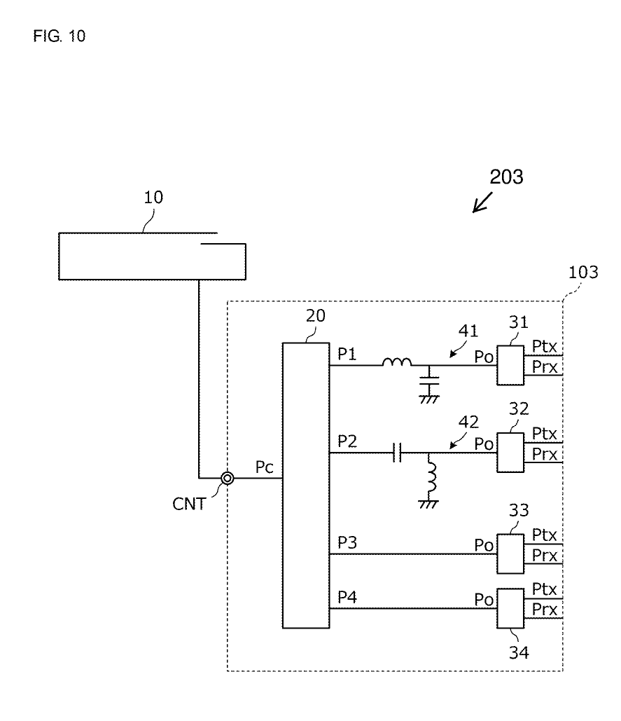

FIG. 10 is a circuit diagram of a front-end circuit 103 and an antenna circuit 203 according to the third embodiment. The antenna circuit 203 is composed of the front-end circuit 103 and the antenna 10.

The front-end circuit 103 includes the band switching unit 20, the demultiplexers 31, 32, 33, and 34, and the antenna matching circuits 41 and 42. The band switching unit 20 has the common port Pc to which the antenna 10 is connected and multiple individual ports P1 to P4. A 2-way coaxial switch connector CNT is provided between the front-end circuit 103 and the antenna 10.

Each of the demultiplexers 31, 32, 33, and 34 has the transmission-reception signal port Po, the transmission signal port Ptx, and the reception signal port Prx and performs demultiplexing into a transmission signal and a reception signal.

The antenna matching circuit 41 and 42 are provided between the individual ports P1 and P2 of the band switching unit 20 and the transmission-reception signal ports Po of the demultiplexers 31 and 32, respectively. The individual ports P3 and P4 of the band switching unit 20 are directly connected to the demultiplexers 33 and 34. The individual ports P2 and P4 of the band switching unit 20 are directly connected to the transmission-reception signal ports Po of the demultiplexers 31 and 32 not via the antenna matching circuits 41 and 42, respectively. The remaining configuration of the antenna circuit 203 is the same as that of the antenna circuit 201 described in the first embodiment.

A communication circuit of 699 MHz to 746 MHz (Band12) is connected to the demultiplexer 31, and a communication circuit of 746 MHz to 787 MHz (Band13) is connected to the demultiplexer 32. A communication circuit of 824 MHz to 894 MHz (Band5) is connected to the demultiplexer 33, and a communication circuit of 880 MHz to 960 MHz (Band8) is connected to the demultiplexer 34. In other words, the antenna matching circuits (41 and 42) are provided only for Band12 and Band13 (low-band) and no antenna matching circuit is provided for Band5 and Band8 (high-band) in the front-end circuit 103 of the present embodiment. The above low band is preferably a frequency band of 1 GHz or less.

In the antenna circuit 203 of the present embodiment, a measuring device is connected to the 2-way coaxial switch connector CNT, the band switching unit 20 selects the port P1, and the antenna matching circuit 41 is temporarily replaced with the transmission line to measure the characteristics (for example, output power and input sensitivity) of the circuit not via the antenna matching circuit 41. The band switching unit 20 selects the port P2 and the antenna matching circuit 42 is temporarily replaced with the transmission line to measure the characteristics of the circuit not via the antenna matching circuit 42.

When the measuring device is connected to the coaxial switch connector CNT, the band switching unit is connected to the individual port. Since the coaxial switch connector CNT is a 2-way connector, both the impedance at the antenna 10 side and the impedance at the circuit side can be monitored. Since the rotation of the phase in the band switching unit 20 is short, an optimal value of the matching circuit can be determined.

### Fourth Embodiment

A front-end circuit including multiple band switching units will be described in a fourth embodiment.

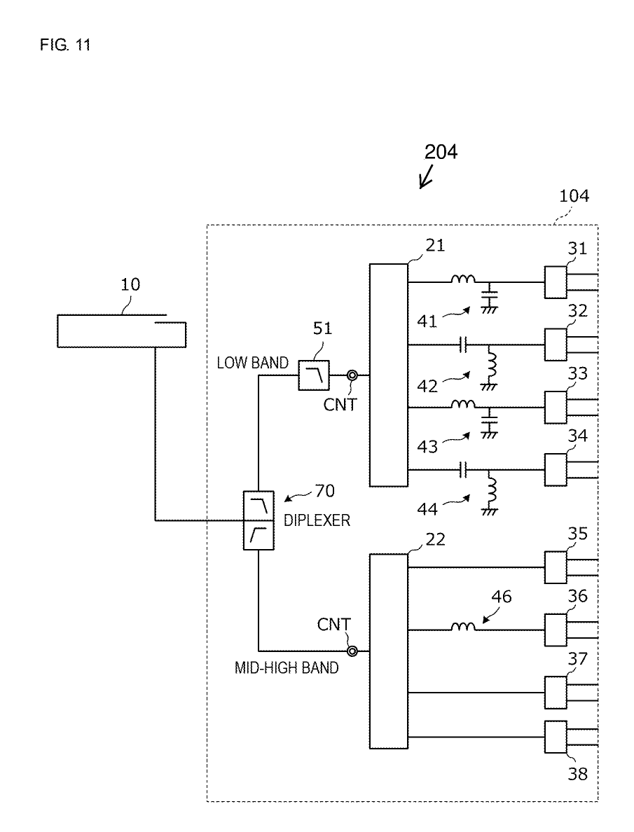

FIG. 11 is a circuit diagram of a front-end circuit 104 and an antenna circuit 204 according to the fourth embodiment. The antenna circuit 204 is composed of the front-end circuit 104 and the antenna 10.

The front-end circuit 104 includes a diplexer 70, a low pass filter 51, band switching units 21 and 22, the demultiplexers 31, 32, 33, and 34, demultiplexers 35, 36, 37, and 38, the antenna matching circuits 41, 42, 43, and 44, and an antenna matching circuit 46. The 2-way coaxial switch connector CNT is provided for the common port of each of the band switching units 21 and 22.

The diplexer 70 performs demultiplexing into a low band signal and a mid-high band signal. The low pass filter 51 attenuates the mid-high band signal. In the carrier aggregation, the diplexer 70 may be used in order to separate the lower band and the higher band, as in this example.

As described above, the switch connectors CNT, the diplexer 70, and the low pass filter 51, which are provided for input-output checking, may be provided between the antenna 10 and the band switching units 21 and 22 for band switching. Since the switch connector CNT is a 2-way connector, both the impedance at the antenna 10 side and the impedance at the circuit side can be monitored.

Since the rotation of the phase in the band switching unit 21 and 22 is short, the provision of the switch connector CNT between the antenna 10 and the band switching unit 21 and 22 enables the impedance of the antenna 10 to be monitored to determine the matching circuit optimal for each frequency band without the switch connector provided before the demultiplexer of each frequency band. In other words, it is possible to determine which antenna matching circuit is optimal for each frequency band, among the antenna matching circuits 41, 42, 43, 44, and 46, so as to match the impedance at the circuit side from the impedance at the antenna 10 side.

Since the antenna is designed so as to be shorter than the wavelength in its resonant mode with a decrease in size of an electronic device into which the antenna is incorporated, the radiation resistance in the high band is higher than that in the low band. In other words, the necessity to provide the matching circuit in the high band is lower than that in the low band. According to the present embodiment, the antenna tuner is omitted while keeping quality characteristics.

### Fifth Embodiment

An example having a different structure to supply power to the antenna will be described in a fifth embodiment.

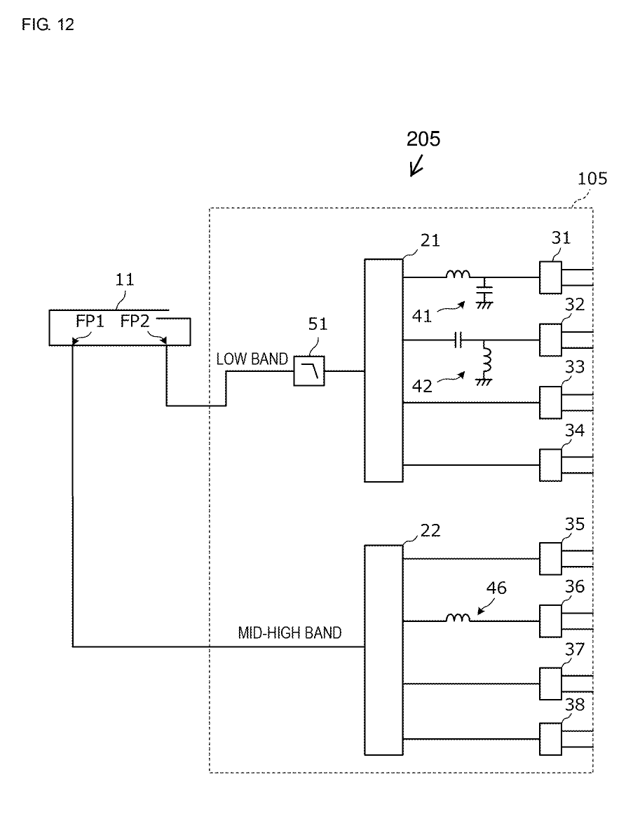

FIG. 12 is a circuit diagram of a front-end circuit 105 and an antenna circuit 205 according to the fifth embodiment. The antenna circuit 205 is composed of the front-end circuit 105 and an antenna 11. The antenna 11 has two feed points FP1 and FP2. A mid-high band signal is supplied to the feed point FP1 and a low band signal is supplied to the feed point FP2.

The front-end circuit 105 includes the low pass filter 51, the band switching units 21 and 22, the demultiplexers 31, 32, 33, 34, 35, 36, 37, and 38, and the antenna matching circuits 41, 42, and 46.

The diplexer may not be provided in the case in which the front-end circuit 105 is connected to the different feed points FP1 and FP2 of the antenna 11 to ensure isolation between the two feed points FP1 and FP2. Accordingly, insertion loss caused by the diplexer is eliminated.

The number of the feed points for the respective frequency bands is not limited to two and three or more feed points may be provided.

### Sixth Embodiment

An antenna circuit in which, for example, a matching circuit is directly connected to the antenna will be described in a sixth embodiment.

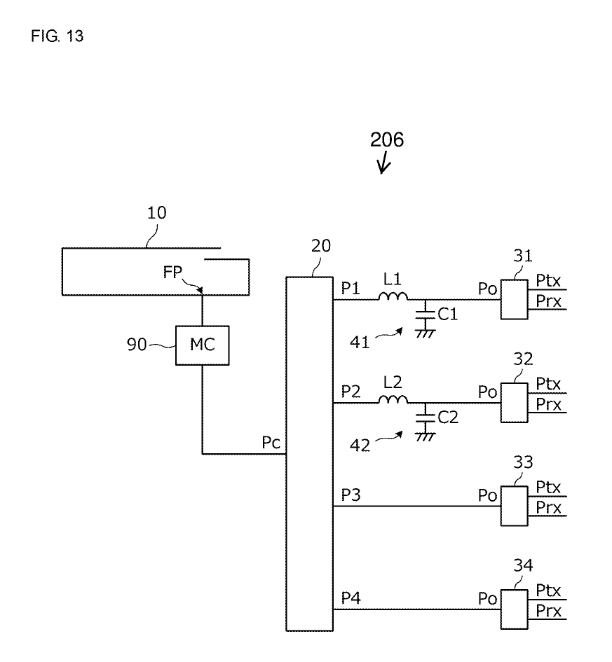

FIG. 13 is a circuit diagram of an antenna circuit 206 according to the sixth embodiment. A matching circuit 90 is connected between the antenna 10 and the band switching unit 20 (is directly connected to the antenna 10). In other words, the band switching unit 20 is indirectly connected to the antenna 10. The remaining configuration of the antenna circuit 206 is the same as that of the antenna circuit 201 illustrated in FIG. 1 in the first embodiment. The matching circuit 90 is a circuit composed of only a passive element, unlike an antenna tuner including an active circuit. This is because, when the antenna tuner includes an active reactance element and is disposed between the antenna 10 and the band switching unit 20 (is directly connected to the antenna 10), the frequency band subjected to the matching with the antenna tuner is limited. Accordingly, optimal matching may not be achieved depending on the frequency and, thus, excellent antenna performance is not given at frequencies at which sufficient return loss is not achieved.

Accordingly, the disposition of a circuit composed of only a passive element between the antenna 10 and the band switching unit 20 (the direct connection of a circuit composed of only a passive element to the antenna 10) may provide excellent antenna performance even at frequencies at which sufficient return loss is not achieved. The direct connection of the matching circuit 90 commonly used for all the frequency bands to the antenna 10 in the above manner enables the frequency characteristics of the antenna 10 to be optimized.

Since the harmonic distortion or the intermodulation distortion may be caused even with a field effect transistor (FET) composing the band switching unit 20, a low pass filter that removes the frequency components of the above distortion may be provided between the antenna 10 and the band switching unit 20. Although an example of the typical branched monopole is illustrated as the design of the antenna, the design of the antenna is not limited to this.

### Seventh Embodiment

A communication apparatus will be described in a seventh embodiment.

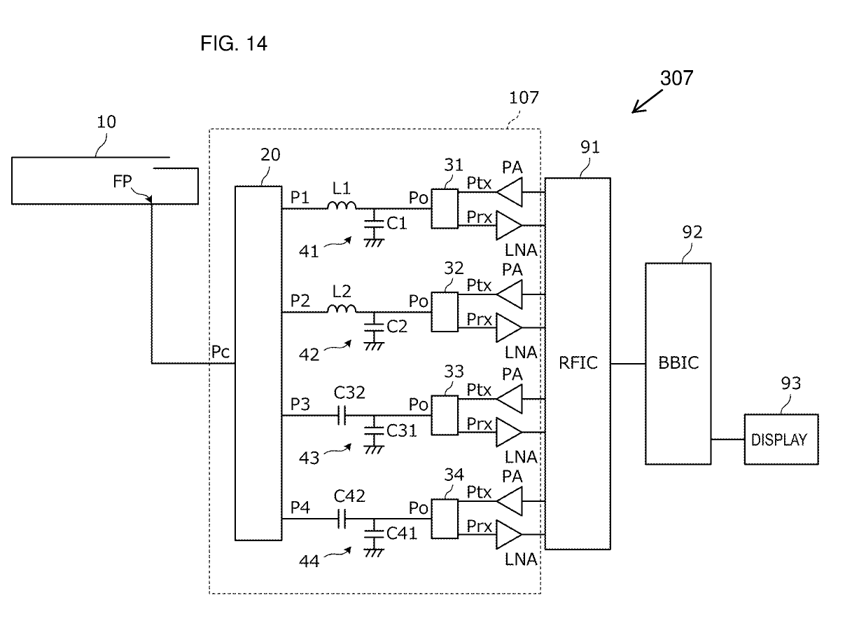

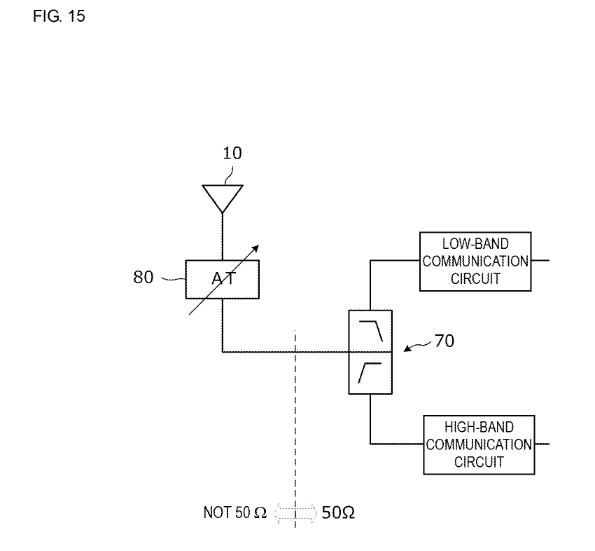

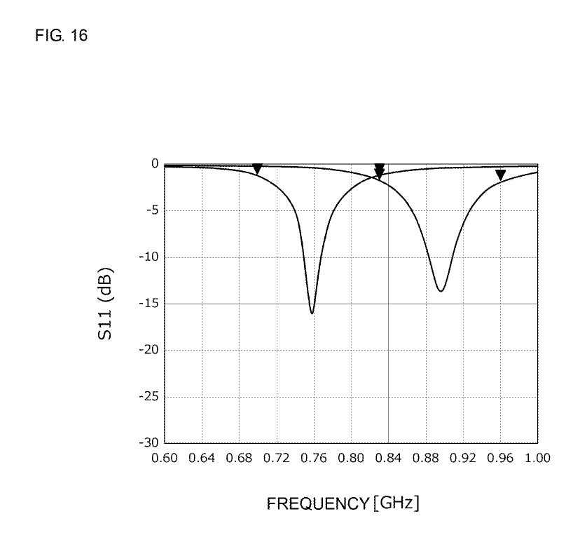

FIG. 14 is a block diagram of a communication apparatus 307 according to the seventh embodiment. The communication apparatus 307 is, for example, a cellular phone terminal.

The communication apparatus 307 includes the antenna 10, a front-end circuit 107, a radio frequency integrated circuit (RFIC) 91, a base band integrated circuit (BBIC) 92, a display 93, and so on. The RFIC 91 is an example of a communication circuit according to the present disclosure.

The front-end circuit 107 includes the band switching unit 20, the demultiplexers 31, 32, 33, and 34, the antenna matching circuits 41, 42, 43, and 44, power amplifiers PA, and low noise amplifiers LNA, which compose one module. The configuration of the band switching unit 20, the demultiplexers 31, 32, 33, and 34, the antenna matching circuits 41, 42, 43, and 44 is the same as the one described in the first embodiment.

The power amplifiers PA are connected to the transmission signal ports of the demultiplexers 31, 32, 33, and 34, and the low noise amplifiers LNA are connected to the reception signal ports of the demultiplexers 31, 32, 33, and 34. The power amplifier PA amplifies the power of a transmission signal and the low noise amplifier LNA amplifies a reception signal.

The RFIC 91 and the display 93 are connected to the BBIC 92.

Finally, all the points in the description of the above embodiments are only examples and the embodiments are not limited to the above description. Appropriate modifications and changes will be obvious to those skilled in the art. For example, components described in different embodiments may be partially replaced or combined with each other. The spirit and scope of the present disclosure are shown not by the above embodiments but by the spirit and scope of the appended claims. The equivalent meaning of the spirit and scope of the appended claims and all the changes within the spirit and scope of the appended claims are intended to be included in the spirit and scope of the present disclosure.
CNT coaxial switch connector
FP, FP1, FP2 feed points
P1, P2, P3, P4, P5, P6 individual ports
Pc common port
Po transmission-reception signal port
Prx reception signal port
Ptx transmission signal port
Xp, Xp1, Xp2, Xp3, Xp4 reactance elements
Xs, Xs1, Xs2, Xs3, Xs4 reactance elements
9 feed circuit
10, 11 antennas
20, 21, 22 band switching units
31, 32, 33, 34, 35, 36, 37, 38 demultiplexers
40, 41, 42, 43, 44, 46 antenna matching circuits
51 low pass filter
60 transmission line
70 diplexer
80 antenna tuner
90 matching circuit
91 RFIC
92 BBIC
93 display
101, 102, 103, 104, 105, 107 front-end circuits
201, 202, 203, 204, 205, 206 antenna circuits
307 communication apparatus

1. A front-end circuit comprising:
a band switching unit directly or indirectly connected to an antenna and switching connection to a frequency band used in transmission and reception, among a plurality of frequency bands;
a plurality of demultiplexers performing demultiplexing into transmission signals and reception signals in the respective frequency bands; and
an antenna matching circuit,
wherein the antenna matching circuit is disposed between at least one demultiplexer, among the plurality of demultiplexers, and the band switching unit.

2. The front-end circuit according to claim 1,
wherein the antenna matching circuit is connected to a side of the band switching unit from the plurality of demultiplexers.

3. The front-end circuit according to claim 1,
wherein the antenna matching circuit is directly connected to the band switching unit.

4. The front-end circuit according to claim 1,
wherein the antenna matching circuit includes a reactance element connected in series to a circuit connecting the band switching unit to the demultiplexer and a reactance element connected in parallel thereto.

5. The front-end circuit according to claim 1,
wherein a length of a transmission line between the antenna and the band switching unit is 0.05 of wavelength or less.

6. The front-end circuit according to claim 1,
wherein neither an antenna tuner containing a semiconductor as a major component nor an antenna tuner including a passive element is disposed between the antenna and the band switching unit.

7. The front-end circuit according to claim 1,
wherein a circuit composed of only a transmission line or a passive element is disposed between the antenna and the band switching unit.

8. The front-end circuit according to claim 1,
wherein the antenna matching circuits are provided between all of the demultiplexers and the band switching unit.

9. The front-end circuit according to claim 1,
wherein the antenna matching circuit is provided only between a demultiplexer performing demultiplexing into a transmission signal and a reception signal in a low frequency band, among the plurality of demultiplexers, and the band switching unit.

10. The front-end circuit according to claim 9,
wherein the low frequency band is a frequency band of 1 GHz or less.

11. The front-end circuit according to claim 1, further comprising:
a power amplifier connected to a transmission signal port of the demultiplexer.

12. An antenna circuit comprising:
the front-end circuit according to claim 1; and
an antenna connected to the front-end circuit.

13. A communication apparatus comprising:
the front-end circuit according to claim 1;
an antenna connected to the front-end circuit; and
a communication circuit connected to the demultiplexers.

14. The front-end circuit according to claim 2,
wherein the antenna matching circuit includes a reactance element connected in series to a circuit connecting the band switching unit to the demultiplexer and a reactance element connected in parallel thereto.

15. The front-end circuit according to claim 3,
wherein the antenna matching circuit includes a reactance element connected in series to a circuit connecting the band switching unit to the demultiplexer and a reactance element connected in parallel thereto.

16. The front-end circuit according to claim 2,
wherein a length of a transmission line between the antenna and the band switching unit is 0.05 of wavelength or less.

17. The front-end circuit according to claim 3,
wherein a length of a transmission line between the antenna and the band switching unit is 0.05 of wavelength or less.

18. The front-end circuit according to claim 4,
wherein a length of a transmission line between the antenna and the band switching unit is 0.05 of wavelength or less.

19. The front-end circuit according to claim 2,
wherein neither an antenna tuner containing a semiconductor as a major component nor an antenna tuner including a passive element is disposed between the antenna and the band switching unit.

20. The front-end circuit according to claim 3,
wherein neither an antenna tuner containing a semiconductor as a major component nor an antenna tuner including a passive element is disposed between the antenna and the band switching unit.
